(19) United States
(12) Patent Application Publication
(10) Pub. No.: US 2024/0279073 A1
(43) Pub. Date: Aug. 22, 2024

(54) ACTIVE METAL-CONTAINING M-CHA/M-MOR COMPOSITE MOLECULAR SIEVE AND PREPARATION METHOD

(71) Applicant: Shaanxi Coal Chemical Industry Technology Research Institute Co., Ltd., Xi'an (CN)

(72) Inventors: Shidong TIAN, Xi'an (CN); Kelun LI, Xi'an (CN); Minhui DANG, Xi'an (CN); Wenquan ZHANG, Xi'an (CN); Li WANG, Xi'an (CN); Hongwei LI, Xi'an (CN); Changluo SU, Xi'an (CN); Binglin DU, Xi'an (CN)

(73) Assignee: Shaanxi Coal Chemical Industry Technology Research Institute Co., Ltd., Xi'an (CN)

(21) Appl. No.: 18/649,524

(22) Filed: Apr. 29, 2024

Related U.S. Application Data
(63) Continuation of application No. PCT/CN2022/139818, filed on Dec. 17, 2022.

(30) Foreign Application Priority Data
Sep. 13, 2022 (CN) 202211109892X

(51) Int. Cl. C01B 39/48

(52) U.S. Cl. CPC C01B 39/48; C01P 2002/72; C01P 2004/03

(57) ABSTRACT

The present disclosure provides an active metal-containing M-CHA/M-MOR composite molecular sieve and a preparation method. The preparation method includes: S1, adding an alkali source, a silicon source, an aluminum source, a structure-directing agent, an active metal complex and a crystal form modifier into water, and performing stirring to obtain a gel, wherein the crystal form modifier is an aqueous solution containing a molecular sieve secondary structural unit prepared based on at least one of an MOR molecular sieve, a CHA/MOR composite molecular sieve, and a CHA-MOR mixed molecular sieve; S2, subjecting the gel to a hydrothermal reaction, and separating the resulting slurry to obtain a composite molecular sieve; and S3, drying the composite molecular sieve, and performing calcining to obtain the active metal-containing M-CHA/M-MOR composite molecular sieve. The direct preparation method has the advantages of short process flow, low wastewater production, low energy consumption and the like.

### CROSS-REFERENCE TO RELATED APPLICATIONS

The application claims priority to Chinese patent application No. 202211109892X, filed on Sep. 13, 2022, the entire contents of which are incorporated herein by reference.

### TECHNICAL FIELD

The present disclosure relates to the field of catalytic materials, in particular to an active metal-containing M-CHA/M-MOR composite molecular sieve and a preparation method.

### BACKGROUND

Molecular sieves are important adsorption/catalytic materials, have physicochemical characteristics such as regular windows, uniform pore channels, large specific surfaces and suitable acidity, and exhibit outstanding advantages in the fields of petrochemical, fine chemical, environmental protection, etc., and have been widely studied and applied. The research results show that active metal-containing M-CHA molecular sieves have excellent SCR catalytic activity, but their hydrothermal stability and resistance to N2O formation are to be improved; active metal-containing M-MOR molecular sieves have excellent hydrothermal stability and resistance to N2O formation, but have a narrow SCR catalytic activity temperature window and limited application areas. Composite molecular sieves have better synergistic effects and often exhibit good properties that a mechanical mixture does not have. By combining the characteristics of the two types of molecular sieves, the comprehensive performance of the composite molecular sieves can be regulated, and thus the composite molecular sieves have wider applicability in the field of waste gas treatment and good application prospects.

Currently, a preparation method for an active metal-containing M-CHA/M-MOR composite molecular sieve has not been reported, and thus, the development of the preparation method is of great significance. Patent document CN108862307A discloses a preparation method for an SSZ-13/MOR eutectic molecular sieve, including mixing an inorganic base, deionized water and a template agent R, then adding an aluminum source and a silicon source, performing uniform stirring and mixing, and performing crystallizing, washing, separating, drying and calcining to obtain the SSZ-13/MOR eutectic molecular sieve. According to the method disclosed, only an alkali metal (such as Na and K) type SSZ-13/MOR eutectic molecular sieve can be obtained, and the eutectic molecular sieve does not have SCR catalytic activity since the alkali metals such as Na and K cannot provide catalytic active sites required for NOx conversion, and how to introduce an active metal M into the molecular sieve is not mentioned. The conventional technical route for introducing the active metal M into the molecular sieve includes: (1) preparing a Na-type or K-type molecular sieve; (2) performing ammonium exchange to obtain an NH4-type molecular sieve, and performing calcination to obtain an H-type molecular sieve, and (3) performing active metal M ion exchange to obtain an active metal M-containing molecular sieve. In each step, processes such as crystallization or ion exchange reactions, washing, separation, drying and calcination are involved. As a whole, the current preparation of molecular sieves containing the active metal M has the defects of complicated process flow, large production amount of washing waste water, and high energy consumption. Therefore, the development of direct preparation of the active metal-containing M-CHA/M-MOR composite molecular sieve is of great significance.

### SUMMARY

In order to overcome the defects in the prior art described above, an object of the present disclosure is to provide an active metal-containing M-CHA/M-MOR composite molecular sieve and a preparation method. Not only can the comprehensive performance of the molecular sieve be regulated and the application field of the molecular sieve be widen, and meanwhile, the present disclosure discloses a direct preparation method for the active metal-containing M-CHA/M-MOR composite molecular sieve, and the preparation method has the advantages of short process flow, small waste water production amount, low energy consumption and the like, and is likely to achieve large-scale industrial application.

The present disclosure is achieved by the following technical solutions:
a preparation method for an active metal-containing M-CHA/M-MOR composite molecular sieve includes:
S1, adding an alkali source, a silicon source, an aluminum source, a structure-directing agent, an active metal complex and a crystal form modifier into water, and performing stirring to obtain a gel, wherein the crystal form modifier is an aqueous solution containing a molecular sieve secondary structural unit prepared based on at least one of an MOR molecular sieve, a CHA/MOR composite molecular sieve, and a CHA-MOR mixed molecular sieve;
S2, subjecting the gel to a hydrothermal reaction, and after the reaction is finished, separating the resulting slurry to obtain a composite molecular sieve; and
S3, drying the composite molecular sieve, and performing calcining to obtain the active metal-containing M-CHA/M-MOR composite molecular sieve.
Preferably, in the S1, the alkali source being in terms of OH—, the silicon source being in terms of SiO2, the aluminum source being in terms of Al2O3, a molar ratio of the alkali source to the silicon source to the aluminum source to the structure-directing agent to the active metal complex is (0.07-0.30):1.00:(0.03-0.15):(0.05-0.20):(0.01-0.10); and the crystal form modifier being in terms of a molecular sieve, a mass ratio of the crystal form modifier to the gel is (0.001-0.010):1.00.

Preferably, in the S1, the active metal complex is prepared from an active metal precursor and a complexing agent, the active metal precursor is one or more of a sulfate, a sulfite, a nitrate, a hydrochloride, and an acetate of an active metal M, the active metal M is one or more of Cu, Fe, Mn, Ce, and Zn, and the complexing agent is one or more of tetraethylenepentamine, disodium ethylenediamine tetraacetate, and dipotassium ethylenediamine tetraacetate.

Preferably, in the S1, a method for preparing the crystal form modifier includes adding at least one of the MOR molecular sieve, the CHA/MOR composite molecular sieve and the CHA-MOR mixed molecular sieve into an alkaline aqueous solution, and then carrying out a reaction at 20-100° C. for 2-24 h to obtain the crystal form modifier.

Preferably, in the S1, the alkali source is one or two of an inorganic alkali and an organic quaternary ammonium alkali, the inorganic alkali is one or two of sodium hydroxide and potassium hydroxide, and the organic quaternary ammonium alkali is one or two of tetramethylammonium hydroxide and tetraethylammonium hydroxide.

Preferably, in the S1, the aluminum source is one or more of aluminum hydroxide, sodium metaaluminate, potassium metaaluminate and aluminum sulfate; the silicon source is one or more of silica sol, sodium silicate and potassium silicate; and the structure-directing agent is one or more of N,N,N-trimethyl-1-adamantylammonium hydroxide, benzyltrimethylammonium hydroxide, and triethylamine.

Preferably, in the S2, the hydrothermal reaction includes a stage I reaction and a stage II reaction, wherein the stage I reaction is carried out at a temperature of 10-90° C. for 1-12 h; and the stage II reaction is carried out at a temperature of 140-200° C. for 48-120 h.

Preferably, the S3 specifically includes: drying the composite molecular sieve, then adding the dried composite molecular sieve and an active metal content regulator into water, carrying out a reaction, separating the resulting slurry after the reaction is finished, and performing drying and calcining to obtain the active metal-containing M-CHA/M-MOR composite molecular sieve.

Further, the active metal content regulator is one or more of ammonium sulfate, ammonium nitrate, ammonium chloride, ammonium carbonate and ammonium bicarbonate.

Further, the composite molecular sieve is dried, then the dried composite molecular sieve and the active metal content regulator are added into the water, and the reaction is carried out at a temperature of 40-90° C. for 2-10 h.

An active metal-containing M-CHA/M-MOR composite molecular sieve obtained by the preparation method has an intergrowth structure of an active metal-containing M-CHA molecular sieve and an active metal-containing M-MOR molecular sieve.

Compared with the prior art, the present disclosure has the following beneficial effects:
the preparation method of the present disclosure adopts the aqueous solution containing the molecular sieve secondary structural unit prepared based on at least one of the MOR molecular sieve, the CHA/MOR composite molecular sieve and the CHA-MOR mixed molecular sieve as the crystal form modifier, the MOR molecular sieve has both an eight-membered ring structure and a twelve-membered ring structure, a CHA molecular sieve has an eight-membered ring structure, thus the obtained crystal form modifier contains both a molecular sieve secondary structural unit of an eight-membered ring and a molecular sieve secondary structural unit of a twelve-membered ring, and the molecular sieve secondary structural unit of the eight-membered ring and the molecular sieve secondary structural unit of the twelve-membered ring can induce the generation of the MOR molecular sieve, and the molecular sieve secondary structural unit of the eight-membered ring can induce the generation of the CHA molecular sieve during the preparation of the molecular sieve of the present disclosure. Thus, a M-CHA/M-MOR intergrowth structure can be successfully prepared by using the crystal form modifier prepared based on at least one of the MOR molecular sieve, the CHA/MOR composite molecular sieve, and the CHA-MOR mixed molecular sieve. M-CHA and M-MOR act synergistically in the obtained active metal-containing M-CHA/M-MOR composite molecular sieve, and the obtained active metal-containing M-CHA/M-MOR composite molecular sieve has both excellent SCR catalytic activity and excellent hydrothermal stability and resistance to N2O formation, and has good comprehensive performance, and wider application fields. In the present disclosure, the active metal-containing M-CHA/M-MOR composite molecular sieve is directly prepared, a complicated ion exchange process is avoided, and the method has the advantages of short process flow, small waste water production amount, low energy consumption, and the like, and is likely to achieve large-scale industrial application.

Further, the crystal form modifier of the present disclosure is prepared in advance and then added into a reaction system, at least one of the MOR molecular sieve, the CHA/MOR composite molecular sieve and the CHA-MOR mixed molecular sieve is added into the alkaline aqueous solution, the reaction is carried out, the molecular sieve secondary structural unit is more easily obtained in a single reaction environment, and adding the obtained crystal form modifier into the reaction system is more conducive to successful preparation of the M-CHA/M-MOR composite molecular sieve in a later stage.

Further, a hydrothermal method of the present disclosure is completed by a two-stage reaction, a stage I reaction is a nucleation reaction and a stage II reaction is a crystal growth process, and a small grain product having a grain size in the range of 100-600 nm can be obtain by the method.

Further, the content of the active metal M can be more accurately regulated by reacting the composite molecular sieve with the active metal content regulator, the active metal content can be adjusted, the product performance can be more accurately controlled, and the product is more suitable for use in the field with high requirements for the product performance.

The active metal-containing M-CHA/M-MOR composite molecular sieve prepared in the present disclosure has both excellent SCR catalytic activity and excellent hydrothermal stability and resistance to N2O formation, and has good comprehensive performance, and wider application fields.

### BRIEF DESCRIPTION OF DRAWINGS

FIG. 1 shows an X-ray diffraction (XRD) pattern of a product C.

FIG. 2 shows an XRD pattern of a H1 molecular sieve.

FIG. 3 shows an XRD pattern of a H2 molecular sieve.

FIG. 4 shows an XRD pattern of a H3 molecular sieve.

FIG. 5 shows an XRD pattern of a H4 molecular sieve.

FIG. 6 shows a scanning electron microscope (SEM) photograph of the H4 molecular sieve.

FIG. 7 shown NOx conversion of the H4 molecular sieve.

FIG. 8 shows N2O formation of the H4 molecular sieve.

FIG. 9 shows an XRD pattern of the H4 molecular sieve before and after hydrothermal aging.

FIG. 10 shows a comparative diagram of NOx conversion of the H4 molecular sieve and a H molecular sieve.

### DETAILED DESCRIPTION OF THE EMBODIMENTS

In order to further understand the present disclosure, the present disclosure is described below with reference to the examples, and these descriptions are only intended to further explain the features and advantages of the present disclosure, and are not intended to limit the claims of the present disclosure.

In the present disclosure, the M-CHA/M-MOR composite molecular sieve represents an intergrowth structure of an M-CHA molecular sieve and an M-MOR molecular sieve, the CHA/MOR composite molecular sieve represents an intergrowth structure of a CHA molecular sieve and an MOR molecular sieve, and the intergrowth structure refers to a composite structure formed by co-growth of two or more molecular sieves in the same reaction system and under the same reaction conditions, wherein “/” represents “and”, wherein “M-” represents a supported active metal, and is one or more of Cu, Fe, Mn, Ce, and Zn. In the present disclosure, the CHA-MOR mixed molecular sieve refers to a mixed molecular sieve obtained by physically mixing the CHA molecular sieve with the MOR molecular sieve. In the present disclosure, the CHA molecular sieve represents a chabazite-type molecular sieve, and the MOR molecular sieve represents a mordenite-type molecular sieve. In the present disclosure, the molecular sieve secondary structural unit refers to a multi-membered ring structure composed of silicon-oxygen tetrahedrons by sharing oxygen atoms according to different connection modes.

A preparation method for an active metal-containing M-CHA/M-MOR composite molecular sieve of the present disclosure specifically includes:

Step S1: an alkali source, a silicon source, an aluminum source, a structure-directing agent, an active metal complex, and deionized water are added into a reaction vessel, then a crystal form modifier is added, and uniform stirring is performed to obtain a gel.

Wherein the crystal form modifier is an aqueous solution containing a molecular sieve secondary structural unit prepared based on at least one of an MOR molecular sieve, a CHA/MOR composite molecular sieve, and a CHA-MOR mixed molecular sieve. A method for preparing the crystal form modifier specifically includes adding at least one of the MOR molecular sieve, the CHA/MOR composite molecular sieve and the CHA-MOR mixed molecular sieve into an alkaline aqueous solution having a pH of 13.0-14.0, and then carrying out a reaction at 20-100° C. for 2-24 h to obtain the crystal form modifier.

The crystal form modifier is separately prepared in the present disclosure, compared with directly adding at least one of the MOR molecular sieve, the CHA/MOR composite molecular sieve, and the CHA-MOR mixed molecular sieve into a complex gel system to prepare a molecular sieve, the molecular sieve secondary structural unit is more easily obtained in a single reaction environment in the present disclosure, and adding the obtained crystal form modifier into a reaction system is more conducive to successful preparation of the M-CHA/M-MOR composite molecular sieve in a later stage.

Since the MOR molecular sieve has both an eight-membered ring structure and a twelve-membered ring structure, and the CHA molecular sieve has an eight-membered ring structure, the obtained crystal form modifier contains both a molecular sieve secondary structural unit of an eight-membered ring and a molecular sieve secondary structural unit of a twelve-membered ring, and the molecular sieve secondary structural unit of the eight-membered ring and the molecular sieve secondary structural unit of the twelve-membered ring can induce the generation of the MOR molecular sieve, and the molecular sieve secondary structural unit of the eight-membered ring can induce the generation of the CHA molecular sieve. Thus, a M-CHA/M-MOR intergrowth structure can be successfully prepared by using the crystal form modifier prepared based on at least one of the MOR molecular sieve, the CHA/MOR composite molecular sieve, and the CHA-MOR mixed molecular sieve.

Wherein the alkali source is one or two of an inorganic alkali and an organic quaternary ammonium alkali, the inorganic alkali is one or two of sodium hydroxide and potassium hydroxide, and the organic quaternary ammonium alkali is one or two of tetramethylammonium hydroxide and tetraethylammonium hydroxide; the aluminum source is one or more of aluminum hydroxide, sodium metaaluminate, potassium metaaluminate, and aluminum sulfate; the silicon source is one or more of silica sol, sodium silicate and potassium silicate; and the structure-directing agent is one or more of N,N,N-trimethyl-1-adamantylammonium hydroxide, benzyltrimethylammonium hydroxide, and triethylamine.

Wherein the active metal complex is prepared from an active metal precursor and a complexing agent, the active metal precursor is one or more of a sulfate, a sulfite, a nitrate, a hydrochloride, and an acetate of an active metal in various valence states, the active metal M is one or more of Cu, Fe, Mn, Ce, and Zn, and the complexing agent is one or more of tetraethylenepentamine, disodium ethylenediaminetetraacetic acid, and dipotassium ethylenediaminetetraacetic acid. The active metal complex can be present in solution in an alkaline environment required for molecular sieve synthesis, avoiding precipitation of the active metal precursor in the alkaline environment, thereby making it difficult for the active metal to enter a framework structure of the molecular sieve.

In the gel system, a molar ratio of the alkali source (in terms of OH—) to the silicon source (in terms of SiO2) to the aluminum source (in terms of Al2O3) to the structure-directing agent to the active metal complex is (0.07-0.30):1.00:(0.03-0.15):(0.05-0.20):(0.01-0.10), and the crystal form modifier being in terms of a molecular sieve, a mass ratio of the crystal form modifier to the gel is (0.001-0.010):1.00.

Step S2: The gel is subjected to a stage I reaction at 10-90° C. for 1-12 h in the reaction vessel, then a stage II reaction is carried out at 140-200° C. for 48-120 h to obtain a slurry, and the obtained slurry is separated to obtain a composite molecular sieve.

A hydrothermal method of the present disclosure is completed by a two-stage reaction, the stage I reaction is a nucleation reaction and the stage II reaction is a crystal growth process, the hydrothermal reaction is divided into a two-stage reaction, a large amount of reactants are first subjected to a reaction to generate crystal nuclei, and then the crystal nuclei grow, and thus, a small grain product can be obtain by the method.

Step S3: The composite molecular sieve is dried at 100-300° C., and calcined at 500-800° C. to obtain an active metal-containing M-CHA/M-MOR composite molecular sieve product; and the molecular sieve product is used as a catalyst in the fields of environmental protection and industrial catalysis directly or after molding.

Or, this step can also be carried out as follows: the composite molecular sieve and an active metal content regulator are added into deionized water, wherein a liquid-solid ratio of the water to the composite molecular sieve is 2-10, the active metal content regulator has a concentration of 0.1-2.0 M, a reaction is carried out at 40-90° C. for 2-10 h, and after the reaction is finished, the obtained slurry is filtered, dried at 100-300° C., and calcined at 500-800° C. to obtain the active metal-containing M-CHA/M-MOR composite molecular sieve product; and the molecular sieve product is used as a catalyst in the fields of environmental protection and industrial catalysis directly or after molding.

The active metal content regulator is one or more of ammonium sulfate, ammonium nitrate, ammonium chloride, ammonium carbonate and ammonium bicarbonate.

During this reaction, the active metal content regulator can react with the active metal on the composite molecular sieve, thus, the content of the active metal M in a target molecular sieve can be more accurately regulated by the reaction between the active metal and the active metal content regulator, the active metal content can be regulated, and the product performance can be more accurately controlled, making the product more suitable for use in the field with high requirements for the product performance.

The obtained active metal-containing M-CHA/M-MOR composite molecular sieve has an intergrowth structure of the M-CHA molecular sieve and the M-MOR molecular sieve containing at least one active metal of Cu, Fe, Mn, Ce, and Zn, and the active metal content is 0.5 wt %-6.0 wt %.

Several examples and comparative examples are given below.

### COMPARATIVE EXAMPLE

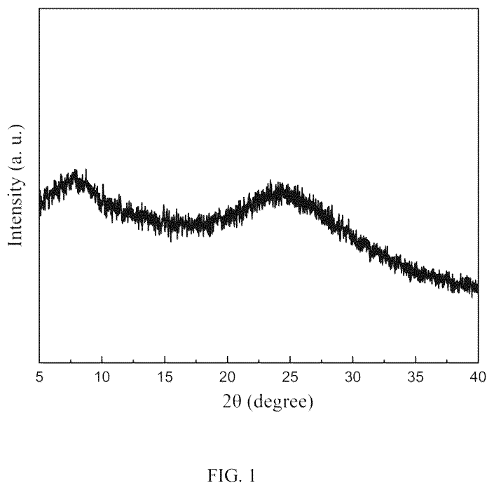

4.6 g of sodium hydroxide, 127.1 g of silica sol, 7.9 g of sodium metaaluminate, 85.9 g of N,N,N-trimethyl-1-adamantylammonium hydroxide, and 11.5 g of a copper sulfate-tetraethylenepentamine complex were added into a reaction vessel charged with deionized water, deionized water was supplemented, uniform stirring was performed to obtain 600.0 g of a gel, a reaction was first carried out at 20° C. for 8 h, then the reaction temperature was raised to 150° C., and a reaction was carried out for 108 h. After completion of the reaction, a slurry was washed and filtered to obtain a solid product, and the solid product was dried at 180° C. and then calcined at 550° C. for 10 h to obtain an amorphous product (C), and an XRD pattern of the amorphous product is shown in FIG. 1.

### Example 1

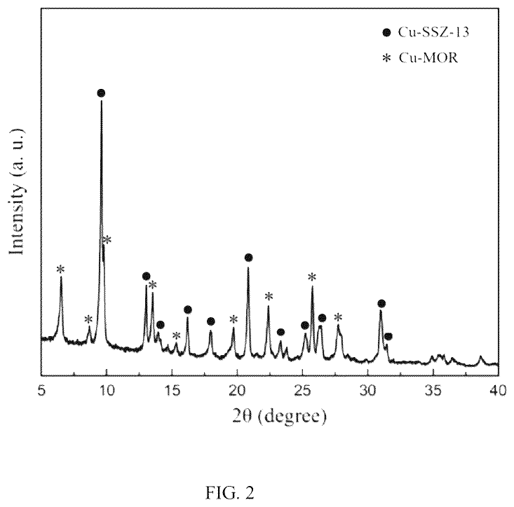

0.2 g of a Cu-MOR molecular sieve and 1.6 g of a Cu-SSZ-13 molecular sieve were added into an aqueous potassium hydroxide solution having a pH of 13.5, and then heating was performed at 90° C. for 4 h to obtain a crystal form modifier. 16.7 g of potassium hydroxide, 183.0 g of silica sol, 6.6 g of aluminum hydroxide, 54.1 g of N,N,N-trimethyl-1-adamantylammonium hydroxide, and 11.9 g of a copper nitrate-tetraethylenepentamine complex were added into a reaction vessel charged with deionized water, the crystal form modifier was added, deionized water was supplemented, uniform stirring was performed to obtain 600.0 g of a gel, a reaction was first carried out at 70° C. for 2 h, then the reaction temperature was raised to 180° C., and a reaction was carried out for 60 h. After completion of the reaction, a slurry was washed and filtered to obtain a solid product, and the solid product was dried at 150° C., and then calcined at 750° C. for 2 h to obtain a Cu-SSZ-13/Cu-MOR composite molecular sieve (H1) having a Cu content of 2 wt %, and an XRD pattern of the H1 molecular sieve is shown in FIG. 2.

### Example 2

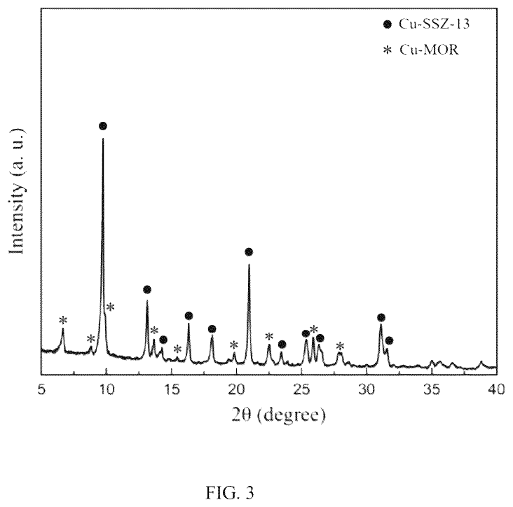

1.2 g of an H-SSZ-13/H-MOR molecular sieve was added into an aqueous sodium hydroxide solution having a pH of 13.0, and then heating was performed at 70° C. for 8 h to obtain a crystal form modifier. 12.1 g of sodium hydroxide, 271.7 g of silica sol, 12.7 g of sodium metaaluminate, 91.7 g of N,N,N-trimethyl-1-adamantylammonium hydroxide, and 27.1 g of a copper chloride-tetraethylenepentamine complex were added into a reaction vessel charged with deionized water, the crystal form modifier was added, deionized water was supplemented, uniform stirring was performed to obtain 600.0 g of a gel, a reaction was first carried out at 60° C. for 4 h, then the reaction temperature was raised to 175° C., and a reaction was carried out for 72 h. After completion of the reaction, a slurry was washed and filtered to obtain a solid product. The solid product and ammonium sulfate were added into deionized water, wherein a liquid-solid ratio of the water to the solid product was 4, and ammonium sulfate has a concentration of 1.5 M, and the above system was subjected to a reaction at 75° C. for 4 h. After the reaction was completed, a slurry was washed and filtered to obtain a filter cake, and the filter cake was dried at 120° C. and then calcined at 700° C. for 4 h to obtain a Cu-SSZ-13/Cu-MOR composite molecular sieve (H2) having a Cu content of 4 wt %, and an XRD pattern of the H2 molecular sieve is shown in FIG. 3.

### Example 3

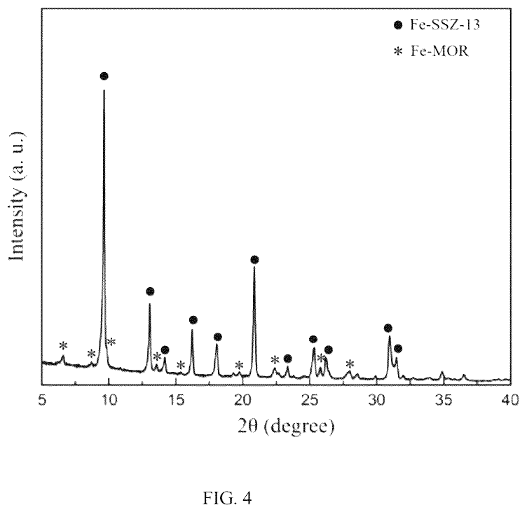

2.4 g of a Fe-MOR molecular sieve was added into an aqueous sodium hydroxide solution having a pH of 13.5, and then heating was performed at 60° C. for 12 h to obtain a crystal form modifier. 5.2 g of sodium hydroxide, 142.0 g of silica sol, 8.8 g of sodium metaaluminate, 83.9 g of N,N,N-trimethyl-1-adamantylammonium hydroxide, and 9.3 g of a ferrous sulfate-disodium ethylenediaminetetraacetate complex were added into a reaction vessel charged with deionized water, the crystal form modifier was added, deionized water was supplemented, uniform stirring was performed to obtain 600.0 g of a gel, a reaction was first carried out at 20° C. for 10 h, then the reaction temperature was raised to 170° C., and a reaction was carried out for 84 h. After completion of the reaction, a slurry was washed and filtered to obtain a solid product. The solid product and ammonium chloride were added into deionized water, wherein a liquid-solid ratio of the water to the solid product was 6, and ammonium chloride has a concentration of 0.5 M, and the above system was subjected to a reaction at 65° C. for 6 h. After completion of the reaction, a slurry was washed and filtered to obtain a filter cake, and the filter cake was dried at 240° C. and then calcined at 650° C. for 6 h to obtain a Fe-SSZ-13/Fe-MOR composite molecular sieve (H3) having a Fe content of 1 wt %, and an XRD pattern of the H3 molecular sieve is shown in FIG. 4.

### Example 4

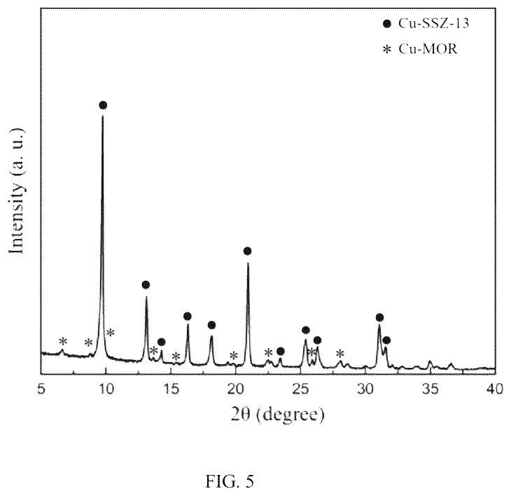

3.0 g of a Cu-MOR molecular sieve was added into an aqueous sodium hydroxide solution having a pH of 13.5, and then heating was performed at 40° C. for 18 h to obtain a crystal form modifier. 4.6 g of sodium hydroxide, 127.1 g of silica sol, 7.9 g of sodium metaaluminate, 85.9 g of N,N,N-trimethyl-1-adamantylammonium hydroxide, and 11.5 g of a copper sulfate-tetraethylenepentamine complex were added into a reaction vessel charged with deionized water, the crystal form modifier was added, deionized water was supplemented, uniform stirring was performed to obtain 600.0 g of a gel, a reaction was first carried out at 20° C. for 8 h, then the reaction temperature was raised to 150° C., and a reaction was carried out for 108 h. After the reaction was completed, a slurry was washed and filtered to obtain a solid product, the solid product and ammonium sulfate were added into deionized water, wherein a liquid-solid ratio of the water to the solid product was 5, and ammonium sulfate has a concentration of 0.5 M, and the above system was subjected to a reaction at 70° C. for 2 h. After the reaction was completed, a slurry was washed and filtered to obtain a filter cake, and the filter cake was dried at 180° C. and then calcined at 550° C. for 10 h to obtain a Cu-SSZ-13/Cu-MOR composite molecular sieve (H4) having a Cu content of 3 wt %, and an XRD pattern of the H4 molecular sieve is shown in FIG. 5.

### Example 5

3.0 g of a Cu-MOR molecular sieve was added into an aqueous sodium hydroxide solution having a pH of 13.5, and then heating was performed at 40° C. for 18 h to obtain a crystal form modifier. 4.6 g of sodium hydroxide, 127.1 g of silica sol, 7.9 g of sodium metaaluminate, 85.9 g of N,N,N-trimethyl-1-adamantylammonium hydroxide, and 11.5 g of a copper sulfate-tetraethylenepentamine complex were added into a reaction vessel charged with deionized water, the crystal form modifier was added, deionized water was supplemented, uniform stirring was performed to obtain 600.0 g of a gel, a reaction was first carried out at 20° C. for 8 h, then the reaction temperature was raised to 150° C., and a reaction was carried out for 108 h. After the reaction was completed, a slurry was washed and filtered to obtain a solid product, and the solid product was dried at 180° C. and then calcined at 550° C. for 10 h to obtain a Cu-SSZ-13/Cu-MOR composite molecular sieve (H) with the Cu content unadjusted.

By comparing FIG. 1 with FIG. 5, it can be seen that when no crystal form modifier was added, only the amorphous product was obtained, and no molecular sieve structure was formed. However, the addition of the crystal form modifier can promote the formation of the Cu-SSZ-13/Cu-MOR composite molecular sieve with high crystallinity.

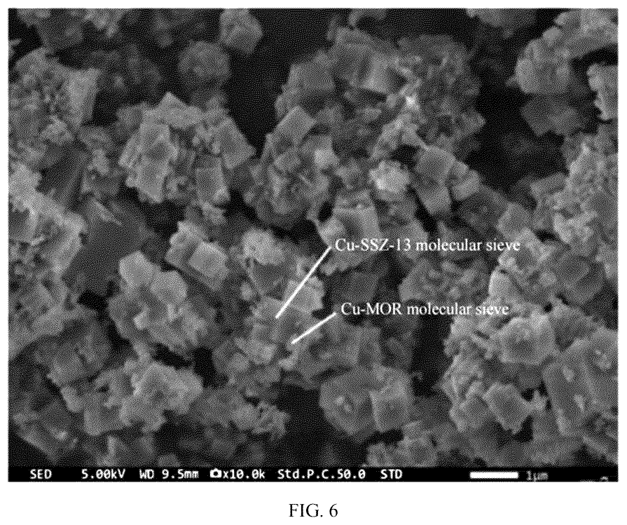

An SEM photograph of the H4 molecular sieve is shown in FIG. 6. It can be seen that the H4 molecular sieve has a typical structure morphology of SSZ-13 and MOR, cubic grains are the Cu-SSZ-13 molecular sieves, and small grains are the Cu-MOR molecular sieves. On a microscopic scale, the Cu-SSZ-13 molecular sieves and the Cu-MOR molecular sieves grow alternately and are distributed more uniformly, indicating that the H4 molecular sieve has an intergrowth structure.

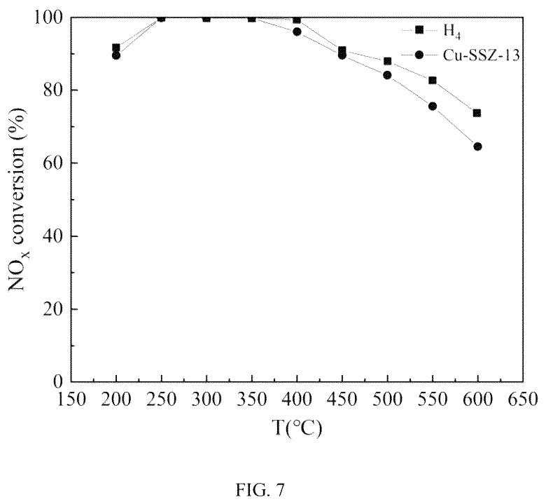

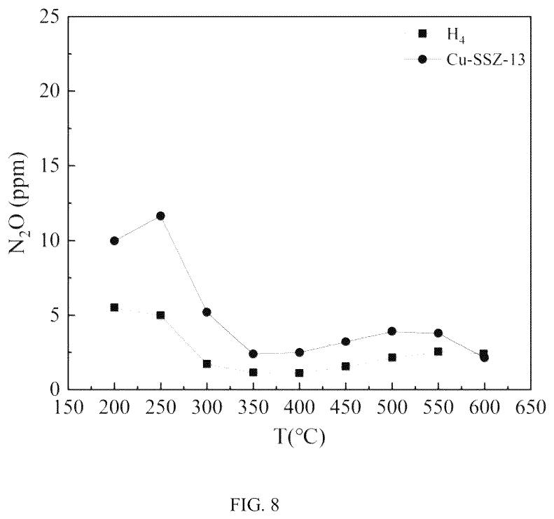

Performance evaluation was performed on the H4 molecular sieve by using a fixed-bed microreactor under the condition of 500 ppm of NO and 500 ppm of NH3. The comparison between a NOx removal rate of the H4 molecular sieve and a NOx removal rate of the Cu-SSZ-13 molecular sieve (belonging to the CHA molecular sieve) is shown in FIG. 7, and the comparison between N2O formation of the H4 molecular sieve and N2O formation of the Cu-SSZ-13 molecular sieve (belonging to the CHA molecular sieve) is shown in FIG. 8. It can be seen from the results that the H4 molecular sieve has a higher NOx removal rate and lower N2O formation, indicating a synergistic effect between CHA and MOR intergrown molecular sieves with the advantages of both molecular sieves.

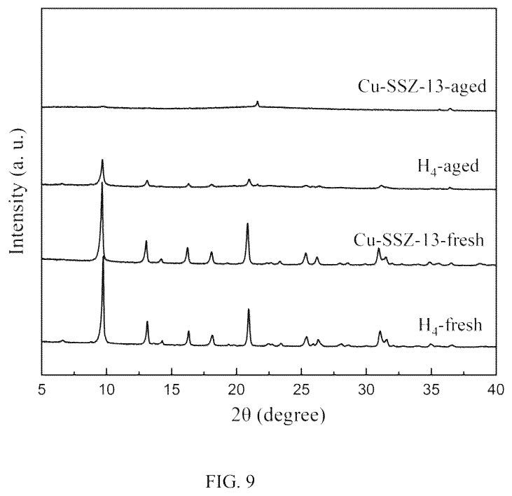

The H4 molecular sieve and the Cu-SSZ-13 molecular sieve were aged in a hydrothermal environment of 850° C. for 12 h, an XRD pattern of fresh molecular sieves and the aged molecular sieves is shown in FIG. 9, and it can be seen from the figure that the intensity of characteristic diffraction peaks of the aged H4 molecular sieve shows a decreasing trend, but characteristic diffraction peaks of CHA/MOR are present at the same time, that is, after aging, although a crystallinity of the H4 molecular sieve decreases, an intergrowth structure of CHA and MOR is still retained; however, characteristic diffraction peaks of the aged Cu-SSZ-13 molecular sieve disappear, indicating a framework structure of the molecular sieve is almost completely collapsed. The above results indicate that the CHA and MOR composite molecular sieve has high hydrothermal stability.

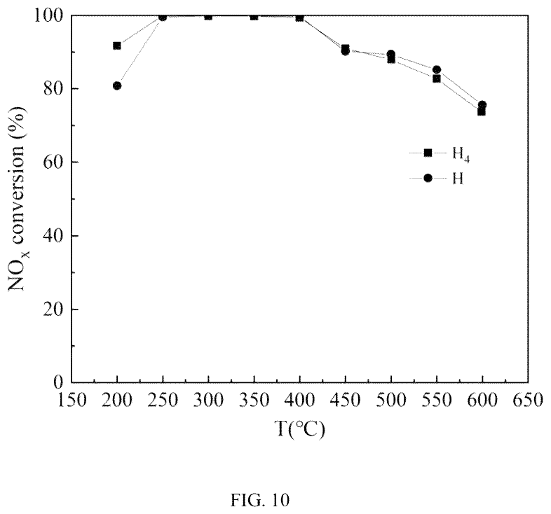

The comparison between the NOx removal rate of the H4 molecular sieve and a NOx removal rate of the H molecular sieve is shown in FIG. 10, the Cu content of the H4 molecular sieve was adjusted while the Cu content of the H molecular sieve was not adjusted, and it can be seen from FIG. 10 that the NOx removal rate of the H4 molecular sieve obtained after the Cu content adjustment is significantly improved in a low temperature range of 200-250° C. compared with the H molecular sieve. It is indicated that adjusting the content of the active metal can control the product performance more accurately, and thus the product is more suitable for use in the field with high requirements for the product performance. The H4 molecular sieve product of the present disclosure is more suitable for treatment of exhaust gas from a mobile source engine with a cold start process.

What is claimed is:

1. A preparation method for an active metal-containing M-CHA/M-MOR composite molecular sieve, comprising:
S1, adding an alkali source, a silicon source, an aluminum source, a structure-directing agent, an active metal complex and a crystal form modifier into water, and performing stirring to obtain a gel, wherein the crystal form modifier is an aqueous solution containing a molecular sieve secondary structural unit prepared based on at least one of an MOR molecular sieve, a CHA/MOR composite molecular sieve, and a CHA-MOR mixed molecular sieve;
S2, subjecting the gel to a hydrothermal reaction, and after the reaction is finished, separating the resulting slurry to obtain a composite molecular sieve; and
S3, drying the composite molecular sieve, and performing calcining to obtain the active metal-containing M-CHA/M-MOR composite molecular sieve.

2. The preparation method for the active metal-containing M-CHA/M-MOR composite molecular sieve according to claim 1, wherein in the S1, the alkali source being in terms of OH⁻, the silicon source being in terms of SiO₂, the aluminum source being in terms of Al₂O₃, a molar ratio of the alkali source to the silicon source to the aluminum source to the structure-directing agent to the active metal complex is (0.07-0.30):1.00:(0.03-0.15):(0.05-0.20):(0.01-0.10); and the crystal form modifier being in terms of a molecular sieve, a mass ratio of the crystal form modifier to the gel is (0.001-0.010):1.00.

3. The preparation method for the active metal-containing M-CHA/M-MOR composite molecular sieve according to claim 1, wherein in the S1, the active metal complex is prepared from an active metal precursor and a complexing agent, the active metal precursor is one or more of a sulfate, a sulfite, a nitrate, a hydrochloride, and an acetate of an active metal M, the active metal M is one or more of Cu, Fe, Mn, Ce, and Zn, and the complexing agent is one or more of tetraethylenepentamine, disodium ethylenediamine tetraacetate, and dipotassium ethylenediamine tetraacetate.

4. The preparation method for the active metal-containing M-CHA/M-MOR composite molecular sieve according to claim 1, wherein in the S1, a method for preparing the crystal form modifier comprises adding at least one of the MOR molecular sieve, the CHA/MOR composite molecular sieve and the CHA-MOR mixed molecular sieve into an alkaline aqueous solution, and then carrying out a reaction at 20-100° C. for 2-24 h to obtain the crystal form modifier.

5. The preparation method for the active metal-containing M-CHA/M-MOR composite molecular sieve according to claim 1, wherein in the S1, the alkali source is one or two of an inorganic alkali and an organic quaternary ammonium alkali, the inorganic alkali is one or two of sodium hydroxide and potassium hydroxide, and the organic quaternary ammonium alkali is one or two of tetramethylammonium hydroxide and tetraethylammonium hydroxide; the aluminum source is one or more of aluminum hydroxide, sodium metaaluminate, potassium metaaluminate, and aluminum sulfate; the silicon source is one or more of silica sol, sodium silicate and potassium silicate; and the structure-directing agent is one or more of N,N,N-trimethyl-1-adamantylammonium hydroxide, benzyltrimethylammonium hydroxide, and triethylamine.

6. The preparation method for the active metal-containing M-CHA/M-MOR composite molecular sieve according to claim 1, wherein in the S2, the hydrothermal reaction comprises a stage I reaction and a stage II reaction, wherein the stage I reaction is carried out at a temperature of 10-90° C. for 1-12 h; and the stage II reaction is carried out at a temperature of 140-200° C. for 48-120 h.

7. The preparation method for the active metal-containing M-CHA/M-MOR composite molecular sieve according to claim 1, wherein the S3 specifically comprises: drying the composite molecular sieve, then adding the dried composite molecular sieve and an active metal content regulator into water, carrying out a reaction, separating the resulting slurry after the reaction is finished, and performing drying and calcining to obtain the active metal-containing M-CHA/M-MOR composite molecular sieve.

8. The preparation method for the active metal-containing M-CHA/M-MOR composite molecular sieve according to claim 7, wherein the active metal content regulator is one or more of ammonium sulfate, ammonium nitrate, ammonium chloride, ammonium carbonate and ammonium bicarbonate.

9. The preparation method for the active metal-containing M-CHA/M-MOR composite molecular sieve according to claim 7, wherein the composite molecular sieve is dried, then the dried composite molecular sieve and the active metal content regulator are added into the water, and the reaction is carried out at a temperature of 40-90° C. for 2-10 h.

10. An active metal-containing M-CHA/M-MOR composite molecular sieve obtained by the preparation method according to claim 1, having an intergrowth structure of an active metal-containing M-CHA molecular sieve and an active metal-containing M-MOR molecular sieve.
